(19) United States
(12) Patent Application Publication
(10) Pub. No.: US 2025/0351191 A1
(43) Pub. Date: Nov. 13, 2025

(54) RANDOM ACCESS CHANNEL ADAPTATION FOR RANDOM ACCESS OCCASIONS

(71) Applicant: QUALCOMM Incorporated, San Diego, CA (US)

(72) Inventors: Navid ABEDINI, Basking Ridge, NJ (US); Aria HASANZADEZONUZY, Chatham, NJ (US); Jianghong LUO, Skillman, NJ (US); Ahmed Attia ABOTABL, San Diego, CA (US)

(21) Appl. No.: 19/203,088

(22) Filed: May 8, 2025

Related U.S. Application Data
(60) Provisional application No. 63/645,686, filed on May 10, 2024.

(51) Int. Cl. H04W 74/0833; H04W 56/00

(52) U.S. Cl. CPC H04W 74/0833; H04W 56/001

(57) ABSTRACT

Methods, systems, and devices for wireless communications are described. A user equipment (UE) may receive a first message indicating a first subset of random access occasions of a set of random access occasions, the first subset of random access occasions associated with use by a first type of UE for transmission of random access messages. The UE may receive, based on the UE being a second type of UE, a second message indicating information associated with one or more random access occasions of the first subset of random access occasions that are unused by the first type of UE. The UE may transmit a random access preamble using a random access occasion from the one or more random access occasions that are unused by the first type of UE.

### CROSS REFERENCES

The present application for patent claims benefit of U.S. Provisional Patent Application No. 63/645,686 by ABEDINI et al., entitled “RANDOM ACCESS CHANNEL ADAPTATION FOR RANDOM ACCESS OCCASIONS,” filed May 10, 2024, assigned to the assignee hereof, and expressly incorporated herein.

### FIELD OF TECHNOLOGY

The following relates to wireless communications, including random access channel adaptation for random access occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDM A), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first message indicating a first subset of random access occasions of a set of random access occasions, the first subset of random access occasions associated with use by a first type of UE for transmission of random access messages, receiving, based on the UE being a second type of UE, a second message indicating information associated with one or more random access occasions of the first subset of random access occasions that are unused by the first type of UE, and transmitting a random access preamble using a random access occasion from the one or more random access occasions that are unused by the first type of UE.

A UE for wireless communications is described. The UE may include one or more memories storing processor executable code, and one or more processors coupled with the one or more memories. The one or more processors may individually or collectively be operable to execute the code to cause the UE to receive a first message indicating a first subset of random access occasions of a set of random access occasions, the first subset of random access occasions associated with use by a first type of UE for transmission of random access messages, receive, based on the UE being a second type of UE, a second message indicating information associated with one or more random access occasions of the first subset of random access occasions that are unused by the first type of UE, and transmit a random access preamble using a random access occasion from the one or more random access occasions that are unused by the first type of UE.

Another UE for wireless communications is described. The UE may include means for receiving a first message indicating a first subset of random access occasions of a set of random access occasions, the first subset of random access occasions associated with use by a first type of UE for transmission of random access messages, means for receiving, based on the UE being a second type of UE, a second message indicating information associated with one or more random access occasions of the first subset of random access occasions that are unused by the first type of UE, and means for transmitting a random access preamble using a random access occasion from the one or more random access occasions that are unused by the first type of UE.

A non-transitory computer-readable medium storing code for wireless communications is described. The code may include instructions executable by one or more processors to receive a first message indicating a first subset of random access occasions of a set of random access occasions, the first subset of random access occasions associated with use by a first type of UE for transmission of random access messages, receive, based on the UE being a second type of UE, a second message indicating information associated with one or more random access occasions of the first subset of random access occasions that are unused by the first type of UE, and transmit a random access preamble using a random access occasion from the one or more random access occasions that are unused by the first type of UE.

In some examples of the method, UEs, and non-transitory computer-readable medium described herein, receiving the second message may include operations, features, means, or instructions for receiving, based on the UE being the second type of UE, an indication of a second subset of random access occasions, where the first subset of random access occasions includes the one or more random access occasions, and the second subset of random access occasions excludes the one or more random access occasions.

In some examples of the method, UEs, and non-transitory computer-readable medium described herein, the second subset of random access occasions corresponds to a set of synchronization signal blocks that may be transmitted by a network entity.

In some examples of the method, UEs, and non-transitory computer-readable medium described herein, the first message indicates a first set of synchronization signal blocks associated with the first subset of random access occasions, and the second message indicates a second set of synchronization signal blocks associated with a second subset of random access occasions and the first set of synchronization signal blocks may be indicated as synchronization signal blocks available for transmission, and the second set of synchronization signal blocks may be indicated as transmitted synchronization signal blocks.

In some examples of the method, UEs, and non-transitory computer-readable medium described herein, the first message indicates a bitmap having a first length to indicate the first set of synchronization signal blocks, and the second message indicates a bitmap having a second length to indicate the second set of synchronization signal blocks, the second length being larger than the first length.

In some examples of the method, UEs, and non-transitory computer-readable medium described herein, the one or more random access occasions may be included in the first subset of random access occasions and excluded by the second subset of random access occasions.

In some examples of the method, UEs, and non-transitory computer-readable medium described herein, the second message indicates the one or more random access occasions that may be unused by the first type of UE, a set of synchronization signal blocks corresponding to the one or more random access occasions that may be unused by the first type of UE, or both.

Some examples of the method, UEs, and non-transitory computer-readable medium described herein may further include operations, features, means, or instructions for receiving a synchronization signal block based on the second message and mapping the synchronization signal block to the random access occasion from the one or more random access occasions that may be unused by the first type of UE based on the first message.

In some examples of the method, UEs, and non-transitory computer-readable medium described herein, the second message indicates the one or more random access occasions that may be unused by the first type of UE and one or more additional random access occasions that may be excluded from the set of random access occasions.

In some examples of the method, UEs, and non-transitory computer-readable medium described herein, the second message may be received via system information, dedicated radio resource control signaling, downlink control information, a medium access control (MAC) control element (CE), or any combination thereof.

Some examples of the method, UEs, and non-transitory computer-readable medium described herein may further include operations, features, means, or instructions for validating the one or more random access occasions based on the second message and the one or more random access occasions being invalidated for the first type of UE.

In some examples of the method, UEs, and non-transitory computer-readable medium described herein, the second message indicates random access occasion resources for the one or more random access occasions including a slot index, random access occasion index, frame index, or any combination thereof, corresponding to random access occasions that may be invalidated for the first type of UE and revalidated for the second type of UE.

Some examples of the method, UEs, and non-transitory computer-readable medium described herein may further include operations, features, means, or instructions for measuring a reference signal to obtain a reference signal received power measurement or a path loss measurement, or both, where transmitting the random access preamble using the random access occasion may be based on the reference signal received power measurement or the path loss measurement, or both, satisfying a threshold.

Some examples of the method, UEs, and non-transitory computer-readable medium described herein may further include operations, features, means, or instructions for identifying the one or more random access occasions that may be unused by the first type of UE based on a first time division duplex pattern indicated for the first type of UE and a second time division duplex pattern indicated by the second message, where the one or more random access occasions correspond to one or more symbols of the second time division duplex pattern that may be not configured for downlink.

Some examples of the method, UEs, and non-transitory computer-readable medium described herein may further include operations, features, means, or instructions for transmitting a capability message indicating a capability of the UE to use random access occasions that may be unused by the first type of UE.

In some examples of the method, UEs, and non-transitory computer-readable medium described herein, the random access preamble may be transmitted using the random access occasion from the one or more random access occasions based on the UE operating in a connected state.

A method for wireless communications by a network entity is described. The method may include transmitting a first message indicating a first subset of random access occasions of a set of random access occasions, the first subset of random access occasions associated with use by a first type of UE for transmission of random access messages, transmitting a second message associated with a second type of UE, the second message indicating information associated with one or more random access occasions of the first subset of random access occasions that are unused by the first type of UE, and receiving a random access preamble via a random access occasion from the one or more random access occasions that are unused by the first type of UE.

A network entity for wireless communications is described. The network entity may include one or more memories storing processor executable code, and one or more processors coupled with the one or more memories. The one or more processors may individually or collectively be operable to execute the code to cause the network entity to transmit a first message indicating a first subset of random access occasions of a set of random access occasions, the first subset of random access occasions associated with use by a first type of UE for transmission of random access messages, transmit a second message associated with a second type of UE, the second message indicating information associated with one or more random access occasions of the first subset of random access occasions that are unused by the first type of UE, and receive a random access preamble via a random access occasion from the one or more random access occasions that are unused by the first type of UE.

Another network entity for wireless communications is described. The network entity may include means for transmitting a first message indicating a first subset of random access occasions of a set of random access occasions, the first subset of random access occasions associated with use by a first type of UE for transmission of random access messages, means for transmitting a second message associated with a second type of UE, the second message indicating information associated with one or more random access occasions of the first subset of random access occasions that are unused by the first type of UE, and means for receiving a random access preamble via a random access occasion from the one or more random access occasions that are unused by the first type of UE.

A non-transitory computer-readable medium storing code for wireless communications is described. The code may include instructions executable by one or more processors to transmit a first message indicating a first subset of random access occasions of a set of random access occasions, the first subset of random access occasions associated with use by a first type of UE for transmission of random access messages, transmit a second message associated with a second type of UE, the second message indicating information associated with one or more random access occasions of the first subset of random access occasions that are unused by the first type of UE, and receive a random access preamble via a random access occasion from the one or more random access occasions that are unused by the first type of UE.

In some examples of the method, network entities, and non-transitory computer-readable medium described herein, transmitting the second message may include operations, features, means, or instructions for transmitting an indication of a second subset of random access occasions, where the first subset of random access occasions includes the one or more random access occasions, and the second subset of random access occasions excludes the one or more random access occasions.

In some examples of the method, network entities, and non-transitory computer-readable medium described herein, the second subset of random access occasions corresponds to a set of synchronization signal blocks that may be transmitted by the network entity.

In some examples of the method, network entities, and non-transitory computer-readable medium described herein, the first message indicates a first set of synchronization signal blocks associated with the first subset of random access occasions, and the second message indicates a second set of synchronization signal blocks associated with a second subset of random access occasions and the first set of synchronization signal blocks may be indicated as synchronization signal blocks available for transmission, and the second set of synchronization signal blocks may be indicated as transmitted synchronization signal blocks.

In some examples of the method, network entities, and non-transitory computer-readable medium described herein, the first message indicates a bitmap having a first length to indicate the first set of synchronization signal blocks, and the second message indicates a bitmap having a second length to indicate the second set of synchronization signal blocks, the second length being larger than the first length.

In some examples of the method, network entities, and non-transitory computer-readable medium described herein, the one or more random access occasions may be included in the first subset of random access occasions and excluded by the second subset of random access occasions.

Some examples of the method, network entities, and non-transitory computer-readable medium described herein may further include operations, features, means, or instructions for transmitting a synchronization signal block from the second set of synchronization signal blocks and receiving, based on the synchronization signal block, the random access preamble via the random access occasion that may be associated with the first set of synchronization signal blocks and not the second set of synchronization signal blocks based on the second message.

In some examples of the method, network entities, and non-transitory computer-readable medium described herein, the second message indicates the one or more random access occasions that may be unused by the first type of UE, a set of synchronization signal blocks corresponding to the one or more random access occasions that may be unused by the first type of UE, or both.

Some examples of the method, network entities, and non-transitory computer-readable medium described herein may further include operations, features, means, or instructions for transmitting a first synchronization signal block based on the second message, where the random access preamble may be received via the random access occasion associated with a second synchronization signal block that may be indicated by the first message and excluded from the second message.

In some examples of the method, network entities, and non-transitory computer-readable medium described herein, the second message indicates the one or more random access occasions that may be unused by the first type of UE and one or more additional random access occasions that may be excluded from the set of random access occasions.

In some examples of the method, network entities, and non-transitory computer-readable medium described herein, the second message may be transmitted via system information, dedicated radio resource control signaling, downlink control information, a MAC CE, or any combination thereof.

In some examples of the method, network entities, and non-transitory computer-readable medium described herein, the second message indicates random access occasion resources for the one or more random access occasions including a slot index, random access occasion index, frame index, or any combination thereof, corresponding to random access occasions that may be invalidated for the first type of UE and revalidated for the second type of UE.

Some examples of the method, network entities, and non-transitory computer-readable medium described herein may further include operations, features, means, or instructions for transmitting a reference signal, where the random access preamble may be received via the random access occasion based on a reference signal received power measurement of the reference signal or a path loss measurement of the reference signal, or both, satisfying a threshold.

Some examples of the method, network entities, and non-transitory computer-readable medium described herein may further include operations, features, means, or instructions for transmitting an indication of a first time division duplex pattern that invalidates the one or more random access occasions, where the second message includes a second time division duplex pattern that validates the one or more random access occasions for the second type of UE.

In some examples of the method, network entities, and non-transitory computer-readable medium described herein, the one or more random access occasions correspond to one or more symbols of the second time division duplex pattern that may be not configured for downlink.

Some examples of the method, network entities, and non-transitory computer-readable medium described herein may further include operations, features, means, or instructions for receiving a capability message indicating a capability of a UE to use random access occasions that may be unused by the first type of UE, where transmitting the second message may be based on the capability of the UE.

In some examples of the method, network entities, and non-transitory computer-readable medium described herein, the random access preamble may be transmitted using the random access occasion from the one or more random access occasions based on one or more UEs operating in a connected state.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access channel adaptation for random access occasions in accordance with one or more aspects of the present disclosure.

FIG. 2 shows an example of a wireless communications system that supports random access channel adaptation for random access occasions in accordance with one or more aspects of the present disclosure.

FIG. 3 shows an example of a process flow that supports random access channel adaptation for random access occasions in accordance with one or more aspects of the present disclosure.

FIGS. 4 and 5 show block diagrams of devices that support random access channel adaptation for random access occasions in accordance with one or more aspects of the present disclosure.

FIG. 6 shows a block diagram of a communications manager that supports random access channel adaptation for random access occasions in accordance with one or more aspects of the present disclosure.

FIG. 7 shows a diagram of a system including a device that supports random access channel adaptation for random access occasions in accordance with one or more aspects of the present disclosure.

FIGS. 8 and 9 show block diagrams of devices that support random access channel adaptation for random access occasions in accordance with one or more aspects of the present disclosure.

FIG. 10 shows a block diagram of a communications manager that supports random access channel adaptation for random access occasions in accordance with one or more aspects of the present disclosure.

FIG. 11 shows a diagram of a system including a device that supports random access channel adaptation for random access occasions in accordance with one or more aspects of the present disclosure.

FIGS. 12 through 14 show flowcharts illustrating methods that support random access channel adaptation for random access occasions in accordance with one or more aspects of the present disclosure.

### DETAILED DESCRIPTION

A wireless communications system may support techniques for network energy savings to reduce power consumption at the network. Network energy savings may be associated with user equipment (UE) capability. For example, a first type of UE may not support network energy savings techniques, and a second type of UE may support network energy savings techniques. Reducing how frequently a network entity monitors for random access signaling, such as during off-peak hours with fewer active UEs, may provide network energy savings. For example, a network entity may reduce a periodicity at which the network entity monitors random access channel resources to reduce activity and power consumption, but the reduced monitoring periodicity may increase latency and power consumption of UEs. To balance between network savings and access latency at UEs, a network entity may adapt random access channel resources to provide additional random access occasions to capable UEs. By adapting random access channel resources, the network entity may provide sufficient random access occasions for the UEs at one time, and the network entity may reduce power consumption by refraining from monitoring for random access signaling at other times. The adapted or additional random access occasions may be activated or deactivated by the network. However, current systems do not provide techniques to adapt or provide additional random access occasions without increasing resource overhead and mitigating increased latency for UEs.

A wireless communication described herein may support techniques to provide additional random access occasions for a UE, such as a network energy savings-capable UE (e.g., the second type of UE). In some examples, the second type of UE may have access to additional random access occasions by reusing one or more random access occasions that are not being used by the first type of UE. In some examples, a UE may identify a random access occasion based on a mapping to a synchronization signal block (SSB) For example, a network entity may indicate a first set of SSBs, and the first set of SSBs may be associated with a first subset of random access occasions. The network entity may indicate, to UEs of the second type (e.g., network energy savings-capable UEs), a second set of SSBs. The second set of SSBs may be actually transmitted by the network entity. For example, the network entity may not actually transmit one or more SSBs of the first set of SSBs, which may result in one or more of the random access occasions of the first set of SSBs not being associated with a transmitted SSB. Random access occasions corresponding to SSBs that are not actually transmitted may be unused by the first type of UE, as the first type of UE may not receive an SSB that maps to these random access occasions. A UE of the second type may identify the unused random access occasions and map the random access occasions (e.g., unused by the first type of UE) to other, valid SSB indexes. The UE of the second type may transmit a random access preamble using a random access occasion associated with an SSB (e.g., according to the mapping of the first type of UEs) that is not actually transmitted.

In some examples, a random access occasion may be invalidated. For example, a random access occasion that is within a threshold quantity of symbol periods after a downlink symbol or an SSB may be invalidated for a UE. The second type of UE may revalidate and use a random access occasion that is invalidated for the first type of UE. For example, the network entity may indicate a first time division duplex (TDD) pattern to the first type of UE and the second type of UE, and one or more random access occasions may be within the threshold quantity of symbol periods after a downlink symbol of the TDD pattern, invalidating the one or more random access occasions. The network entity or the second type of UE, or both, may revalidate the one or more random access occasions for the second type of UE. For example, the network entity may indicate a second TDD pattern or related information to the second type of UE, such that the one or more random access occasions are revalidated where the UE can transmit random access signaling. For example, the network entity may indicate that a downlink symbol period of the first TDD pattern is not used for downlink signaling, such that random access occasions within the threshold quantity of symbol periods after the downlink symbol period can be used by the second type of UE. In some examples, the network entity may indicate, to the second type of UE, additional random access occasions that do not overlap with or correspond to random access occasions for the first type of UE.

Aspects of the disclosure are initially described in the context of wireless communications systems. Aspects of the disclosure are further illustrated by and described with reference to apparatus diagrams, system diagrams, and flowcharts that relate to random access channel adaptation for random access occasions.

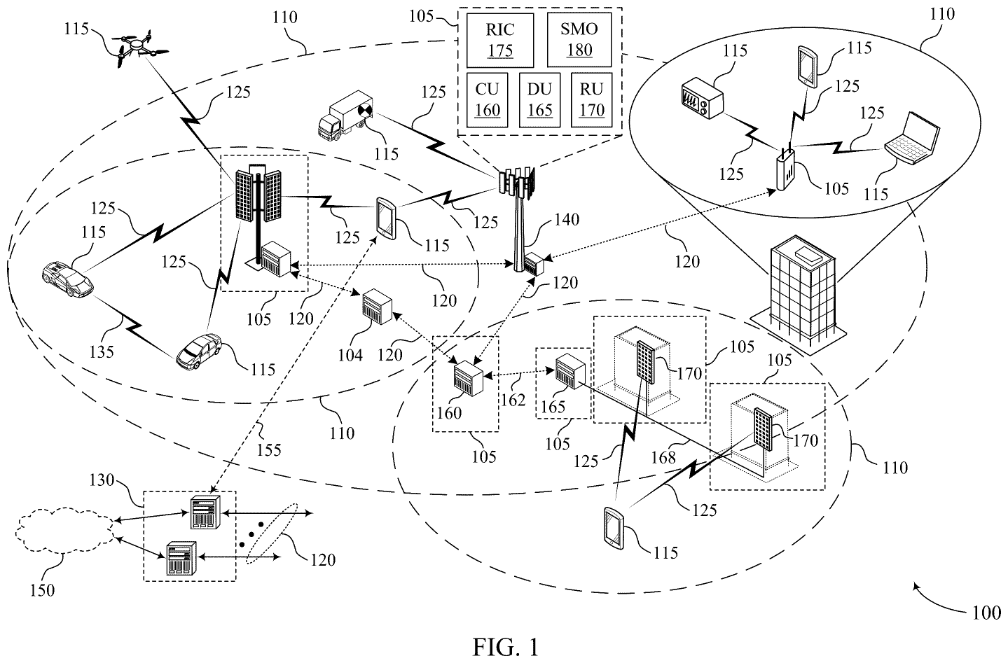

FIG. 1 shows an example of a wireless communications system 100 that supports random access channel adaptation for random access occasions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IM S), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques to reduce network-side power consumption. A UE 115 may be capable of performing network energy saving techniques, and the UE 115 may indicate that the UE 115 is capable of network energy saving techniques. For example, a first type of UE 115 may not support network energy savings techniques, and a second type of UE 115 may support network energy savings techniques. Reducing how frequently a network entity 105 monitors for random access signaling, such as during off-peak hours with fewer active UEs, may provide network energy savings. For example, a network entity 105 may reduce a periodicity at which the network entity 105 monitors random access channel resources to reduce activity and power consumption, but the reduced monitoring periodicity may increase latency and power consumption of UEs 115. To balance between network savings and access latency at UEs 115, a network entity 105 may adapt random access channel resources to provide additional random access occasions to UEs 115 capable of network energy savings techniques.

A UE 115 may receive one or more SSBs of a set of transmitted SSBs corresponding to different beams and map the one or more SSBs to one or more random access occasions. The UE 115 may use a random access occasion corresponding to the received SSB having a highest signal strength to transmit a random access preamble. SSB indexes provided by an SSB indicator may be mapped to valid random access occasions. The SSB indexes may be mapped to valid random access occasions first in an increasing order of preamble indexes within a single random access occasion, second in an increasing order of frequency resource indexes for a frequency multiplexed random access occasion, third in an increasing order of time resource indexes for time multiplexed random access occasions within a random access channel slot, and fourth in an increasing order of indexes for random access channel slots.

In some radio frequency spectrum bands, such as in Frequency Range 2 (FR2), there may be up to 64 SSBs available for a given cell. A network entity 105 may transmit a signal to indicate the presence and absence of transmissions of SSBs in the cell. In some wireless communications, an indicator for SSBs may be 16 bits. Eight bits may be used to indicate the presence or absence of SSBs within a group, and eight bits may be used to indicate the presence or absence of groups. Each group of SSBs may follow a same pattern indicated by the first eight bits if the group is indicated as present by the second group of eight bits.

The wireless communications system 100 may support techniques to provide additional random access occasions for a UE 115, such as a network energy savings-capable UE or the second type of UE 115. In some examples, the second type of UE 115 may have access to additional random access occasions by reusing one or more random access occasions that are not used by the first type of UE 115. These techniques may provide adaptation of random access channel resources in the time domain and mapping for the additional random access channel resources.

In some examples, a network entity 105 may indicate a first set of SSBs, such as via an SSB indicator or a 16-bit SSB indicator. The first set of SSBs may be associated with a first subset of random access occasions. The network entity 105 may indicate, to a UE 115 of the second type (e.g., a UE 115 capable of network energy savings), a second set of SSBs. The second set of SSBs may be actually transmitted by the network entity. For example, the network entity 105 may not actually transmit one or more SSBs of the first set of SSBs, but the random access occasions of the first set of SSBs may still be available. A UE 115 will not receive an SSB that is not actually transmitted and therefore may not use a random access occasion corresponding to that SSB. For example, for a non-transmitted SSB, the first type of UE 115 may not be able to detect the non-transmitted SSB and the corresponding valid random access occasions mapped to the non-transmitted SSB may not be used by the first type of UE 115. A UE 115 of the second type may receive an SSB that is actually transmitted, but the UE 115 of the second type may transmit a random access preamble using a random access occasion associated with one of the non-transmitted SSBs. In some examples, the mapping rules described above may apply for the received SSB to map the received SSB to the random access occasions of a non-transmitted SSB.

In some wireless communications system, a UE 115 may only transmit on a random access occasion that is valid. If the UE 115 is not provided a TDD configuration or TDD pattern, a random access occasion in a random access channel slot may be valid if it does not precede an SSB in the random access channel slot and starts a threshold quantity of symbols, N_{gap}, after a last SSB reception symbol. The candidate SSB index of the SSB may correspond to an SSB index provided by an SSB indicator (e.g., ssb-PositionsInBurst in SIB1) or in a common configuration for a serving cell. If a UE 115 is provided a TDD configuration or a TDD pattern, a random access occasion in a random access channel slot may be valid if it is within uplink symbols. In some examples, a random access occasion in a random access channel slot may be valid if the UE is provided a TDD configuration and the random access occasion does not precede an SSB in the random access channel slot and starts a threshold quantity of symbols after a last downlink symbol and the threshold quantity of symbols after a last SSB symbol. If a random access occasion does not meet these criteria, the random access occasion may be invalidated. For example, if the UE 115 receives a TDD pattern, and the TDD pattern indicates that a random access occasion overlaps with a downlink symbol period, the random access occasion may be invalidated.

In some examples, the second type of UE 115 may revalidate and use a random access occasion that is invalidated for the first type of UE 115. For example, the network entity 105 may indicate a TDD pattern to the first type of UE 115 and the second type of UE 115, where one or more random access occasions are indicated to overlap with a downlink symbol, invalidating the one or more random access occasions. The network entity or the second type of UE 115, or both, may revalidate the one or more random access occasions for the second type of UE 115. For example, the network entity 105 may indicate another TDD pattern or related information to the second type of UE 115, such that the one or more random access occasions are revalidated as corresponding to uplink slots or slots where the UE 115 can transmit random access signaling. In some examples, the network entity 105 may indicate, to the second type of UE 115, additional random access occasions that do not overlap with or correspond to random access occasions for the first type of UE 115.

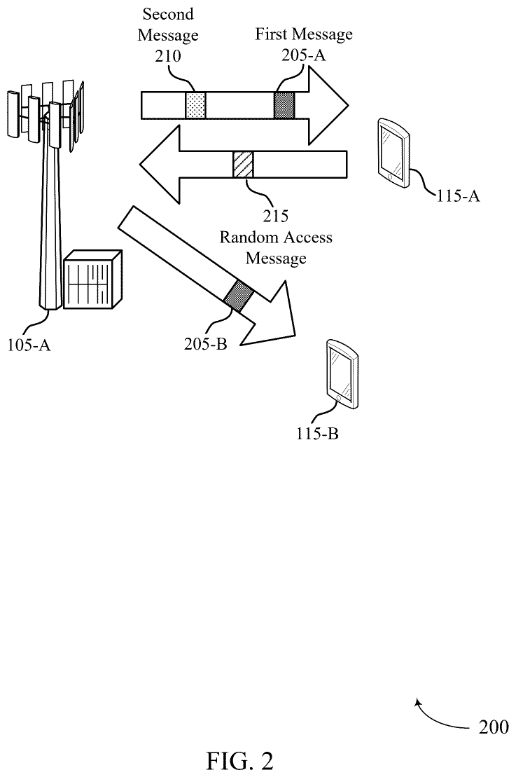

FIG. 2 shows an example of a wireless communications system 200 that supports random access channel adaptation for random access occasions in accordance with one or more aspects of the present disclosure. The wireless communications system 200 may implement aspects of a wireless communications system 100. For example, the wireless communications system 200 may include a UE 115-a, a UE 115-b, and a network entity 105-a. The UE 115-a and the UE 115-b may each be an example of a UE 115 described herein, and the network entity 105-a may be an example of a network entity 105 described herein.

The wireless communications system 200 may support techniques for network energy savings. The UE 115-a may be an example of a second type of UE 115 which is capable of network energy savings techniques. The UE 115-b may be an example of a UE 115 which is not capable of network energy savings techniques. In some examples, the UE 115-a may transmit a capability message to indicate one or more capabilities of the UE 115-a. For example, the capability message may indicate that the UE 115-a is capable of network energy savings techniques or capable of one or more procedures or techniques described herein.

The network entity 105-a and the UE 115-a may support adaptation of random access channel resources. For example, the network entity 105-a may reduce power consumption by changing a frequency at which the network entity 105-a monitors for random access signaling from UEs 115. The network entity 105-a may monitor less frequently for random access preambles, but the network entity 105-a may adapt random access occasions for UEs 115 of the second type to provide additional opportunities for preamble transmission when the network entity 105-a monitors for random access signaling.

In some examples, a UE 115 of the second type, such as the UE 115-a, may reuse random access occasions that are not used by UEs 115 of the first type, such as the UE 115-b. For example, one or more random access occasions may not be used by the first type of UEs 115, and the second type of UEs 115 may reuse a random access occasion from the one or more random access occasions for random access preamble transmission.

In some examples, the network entity 105-a may indicate a first subset of SSBs as being transmitted, but the network entity 105-a may not transmit one or more SSBs of the first subset of SSBs. Random access occasions corresponding to the one or more SSBs may not be used by the first type of UEs 115, as the first type of UEs 115 may not detect an SSB corresponding to the random access occasions. For example, the first type of UEs 115 may detect an actually transmitted SSB and use a random access occasion corresponding to an actually transmitted SSB. The network entity 105-a may indicate a second subset of SSBs that are actually transmitted to the second type of UEs 115. A UE 115 of the second type, such as the UE 115-a, may use a random access occasion corresponding to an SSB of the first subset of SSBs that is not actually transmitted by the network entity 105-a. The UE 115-b may map a received SSB to the random access occasion of the one or more random access occasions that are not used by the first type of UE 115.

In some examples, the network entity 105-a may transmit a first message 205 indicating the first subset of SSBs of a set of available SSBs. The network entity 105-a may not actually transmit one or more SSBs of the first subset of SSBs. The network entity 105-a may transmit a second message 210 indicating a second subset of SSBs that are actually transmitted by the network entity 105-a. The UE 115-a may identify one or more SSBs that are not actually transmitted by the network entity 105-a by comparing the first subset of SSBs and the second subset of SSBs. For example, if an SSB is included in the first subset of SSBs but not the second subset of SSBs, that SSB may not actually be transmitted by the network entity 105-a, and random access occasions corresponding to that SSB may not be used by the first type of UEs 115.

As the random access occasions map to the set of SSBs, there may be a subset of random access occasions configured for the first type of UE 115 that may not be used by the first type of UE 115, such as the UE 115-b. For example, the subset of random access occasions may be mapped to some SSB indices that are not actually being transmitted but may be indicated as being transmitted (e.g., in the first message 205). The subset of random access occasions may be identified and used by the second type of UE 115, such as the UE 115-a.

In some examples, the second type of UE 115 may be indicated the exact set of transmitted SSBs. For example, the first message 205-a may include a 16-bit SSB indicator, with eight bits to indicate which SSBs are present in an SSB group and eight bits to indicate which SSB groups are transmitted or present. The second message 210 may include a 64-bit SSB indicator, which may indicate an exact set of transmitted SSBs. For example, the lower granularity, 16-bit SSB indicator may indicate an SSB index is transmitted, while the higher granularity, 64-bit SSB indicator may indicate that the SSB index is not transmitted. Additionally, or alternatively, the second message 210 may include other information from which the second type of UE 115 may infer which SSBs are or are not actually being transmitted, though these SSBs may be assumed to be transmitted by the first type of UE 115 based on the first message 205.

For example, the UE 115-a may receive a first message 205-a indicating a first subset of SSBs, and the UE 115-b may receive a first message 205-b indicating the first subset of SSBs. In some examples, the first message 205-a and the first message 205-b may correspond to the same signaling or separate signaling. A first message 205 may be indicated via system information.

The UE 115-a may receive a second message 210 indicating a second subset of SSBs based on a capability of the UE 115-a or the UE 115-a being the second type of UE 115. For example, the UE 115-a may receive the second message 210 based on supporting network energy savings techniques or based on supporting random access channel adaptation. The second subset of SSBs may indicate SSBs that are actually transmitted by the network entity 105-a. The second subset of SSBs may be different from the first subset of SSBs, such that one or more SSBs indicated by the first message 205 are then indicated as not actually transmitted by the second message 210. Additionally, or alternatively, the second message 210 may indicate a list of random access occasions or associated SSBs that the UE 115-a can use in association with different SSB indices.

The UE 115-a may identify one or more random access occasions that are not used by the first type of UE 115 based on the first message 205-a and the second message 210. The UE 115-a may apply an SSB-to-random access occasion mapping to the one or more random access occasions. In some examples, a mapping procedure for random access occasions that are not used by the first type of UE 115 may be performed instead of a mapping procedure for random access occasions that are used or usable by the first type of UE 115.

For example, the UE 115-a may be indicated additional random access occasions or additional random access channel resources. In some examples, the additional random access occasions or additional random access channel resources may overlap with random access channel resources configured for the first type of UE 115. For example, the additional random access occasions may correspond to random access occasions that are not used by the first type of UE 115. In some examples, the network entity 105-a may configure additional random access occasions for the second type of UE 115. For example, the UE 115-a may be provided an additional set of random access occasions that are not configured for the first type of UE 115. In some examples, the second message 210 may indicate the additional set of random access occasions.

In some examples, the UE 115-a may apply a same mapping to both, or the union of, the one or more random access occasions that are not used by the first type of UE 115 and additional random access occasions that are not included in a set of random access occasions that are configured for the first type of UE 115. For example, the UE 115-a may also apply the SSB-to-random access occasion mapping to additional random access channel occasions that are configured for the second type of UE 115 and not the first type of UE 115.

In some examples, the UE 115-a may use different mappings for random access occasions that are configured for but not used by the first type of UE 115 and random access occasions that are not configured for the first type of UE 115. For example, the UE 115-a may use two mappings for the two different sets of random access occasions, the first corresponding to the set of random access occasions that are unused by the first type of UE 115, and the second corresponding to an additional set of random access occasions that are only configured for the second type of UE 115.

The techniques for the second type of UE 115 to use random access occasions that are unused by the first type of UE 115 may be enabled for all UEs 115 of the second type or a subset of UEs 115 of the second type. In some examples, these techniques may be enabled for UEs 115 of the second type while operating in any state or only for UEs 115 operating in a connected state. The second message 210 may be indicated to a UE 115 of the second type via different types of signaling, which may be based on a mode of the UE 115. For example, the second message 210 may be transmitted via system information (e.g., broadcasted system information), dedicated RRC signaling (e.g., an RRC release message or an RRC suspend message), or lower-layer signaling (e.g., downlink control information or a MAC control element (CE)).

In some examples, the second type of UE 115 may be allocated additional random access occasions based on revalidating random access occasions that are invalidated for the first type of UE 115. For example, some random access occasions may be treated as invalid, as the random access occasions may precede an SSB in a random access channel slot or may be within a threshold quantity of symbols after a downlink symbol or an SSB. For example, the network entity 105-a may indicate a first set of SSBs (e.g., ssb-positionsInBurst) and a first TDD pattern (e.g., tdd-UL-DL-ConfigurationCommon) to the UE 115-a and the UE 115-b. The first TDD pattern may indicate that one or more random access occasions corresponding to the first set of SSBs are invalid. The network entity 105-a may transmit the second message 210 indicating information such that the UE 115-a may revalidate one or more random access occasions that are invalid for the first type of UE 115.

For example, if the UE 115-a is indicated that some of the SSBs are not actually transmitted, but indicated as transmitted to the first type of UE 115, the UE 115-a may identify one or more random access occasions that may not be treated as valid by the first type of UE 115. For example, these random access occasions may precede SSB occasions in a given RACH slot or may be within N_{gap} symbols after SSB occasions. A subset of random access occasions that are invalidated for the first type of UE 115 may be indicated to and used by the second type of UE 115.

For example, the UE 115-a may revalidate a random access occasion based on receiving information of actually transmitted SSBs. One or more random access occasions that are invalidated for the first type of UE 115 may be revalidated for the UE 115-a based on information of actually transmitted SSBs. For example, the second message 210 may indicate which SSBs are actually transmitted by the network entity 105-a, and the UE 115-a may revalidate one or more random access occasions based on the indication of transmitted SSB s.

In some examples, the UE 115-a may revalidate a random access occasion based on an indication of a new or updated TDD pattern. For example, UEs 115 of the second type may be indicated that some downlink symbols are not used for downlink signaling. The UE 115-a may not invalidate random access occasions within N_{gap} symbols after these downlink symbols, as the downlink symbols may not be used for downlink signaling. The UE 115-a may identify that previously indicated downlink symbols are not used for downlink signaling, and the UE 115-a may revalidate one or more random access occasions. In some examples, the second message 210 may include the new or updated TDD pattern. In some examples, if the network entity 105-a has a low cell load or there is little traffic, the network entity 105-a may not schedule downlink signaling in a subset of downlink symbols next to random access occasions to provide additional random access occasions for the second type of UE 115.

In some examples, to mitigate inter-cell cross-link interference, revalidating random access occasions that are near downlink symbols may be applied by a subset of UEs 115 of the second type. For example, UEs 115 that are near the network entity 105-a or are not near a cell edge of the network entity 105-a may be able to use revalidated random access occasions. For example, the UE 115-a may measure a reference signal from the network entity 105-a. If a measurement of the reference signal, such as a reference signal received power (RSRP) measurement or path loss measurement, satisfies a threshold, the UE 115-a may reuse a random access occasion that the UE 115-a has revalidated.

The network entity 105-a may transmit an explicit indication of revalidated random access occasions to UEs 115 of the second type. For example, the second message 210 may indicate one or more random access occasion that the UE 115-a can revalidate and use to transmit a random access preamble. In some examples, the second message 210 may indicate a slot index, a random access occasion index, a frame index, or any combination thereof, corresponding to random access occasions that the UE 115-a can assume are valid.

In some examples, indicated additional random access channel resources may overlap with invalid random access channel resources for the first type of UE 115. The second type of UE 115 may be able to use a random access occasion that overlaps with these resources if the random access occasion is not used by the first type of UE 115 and is invalid for the first type of UE 115. In some examples, the second type of UE 115 may be configured with additional random access channel resources (e.g., that are not configured for the first type of UE 115), and the network entity 105-a may indicate whether the second type of UE 115 can reuse random access occasions that are not used and are invalidated for the first type of UE 115. Techniques for revalidating a random access occasion may be implemented by all UEs 115 of the second type of a subset of UEs 115 of the second type. For example, UEs 115 of the second type operating in connected mode may be able to revalidate and use random access occasions that are unused and invalidated for the first type of UE 115. In some cases, a UE 115 of the second type may indicate a capability to support revalidating and using random access occasions that are unused and invalid for the first type of UEs 115.

The UE 115-a may transmit a random access message 215 using a random access occasion from the one or more random access occasions that are unused by the first type of UE 115. For example, the UE 115-a may transmit a random access preamble to the network entity 105-a using the random access occasion.

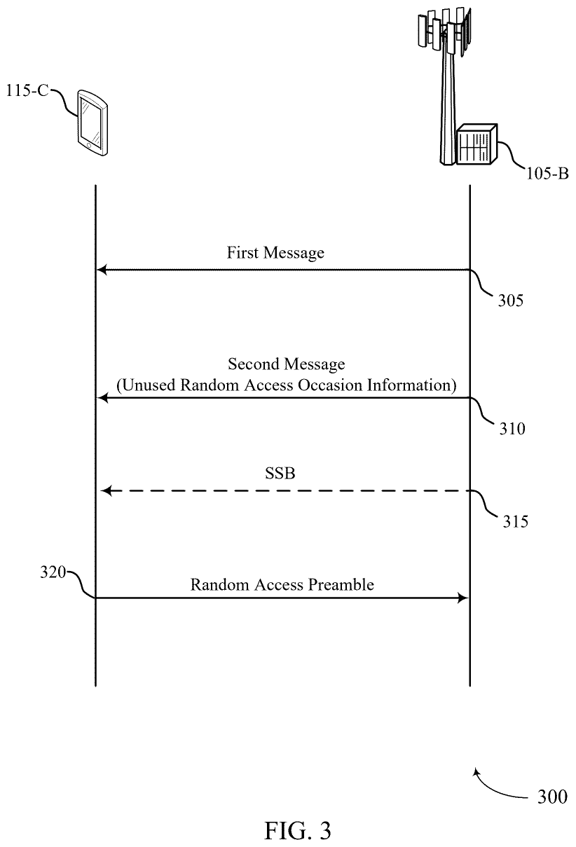

FIG. 3 shows an example of a process flow 300 that supports random access channel adaptation for random access occasions in accordance with one or more aspects of the present disclosure. The process flow 300 may implement aspects of a wireless communications system 100 and a wireless communications system 200. For example, the process flow 300 may be implemented by a UE 115-c or a network entity 105-b, or both, which may be respective examples of a UE 115 and a network entity 105 described herein. In some examples, some processes or signaling of the process flow 300 may occur in a different order than shown. Additionally, or alternatively, some processes or signaling not shown may occur, or some processes or signaling shown may not occur, or both.

The UE 115-c may be an example of a second type of UE 115. For example, the UE 115-c may be capable of network energy savings techniques. A first type of UE 115 may not support network energy savings techniques. The process flow 300 shows techniques for a UE 115 to be configured with additional random access occasions or random access channel resources, which may be used by the UE 115 to provide network energy savings. In some examples, the additional random access channel resources may overlap with or correspond to random access channel resources configured for the first type of UE 115.

At 305, the UE 115-c may receive a first message. For example, the UE 115-c may receive a first message indicating a first subset of random access occasions of a set of random access occasions. The first subset of random access occasions may be associated with use by a first type of UE 115 for transmission of random access occasions. For example, the UE 115-c may receive an indication of a first set of SSBs. The first message may indicate a first set of SSBs associated with the first subset of random access occasions, such as via a 16-bit SSB indicator. In some examples, UEs 115 of the first type and UEs 115 of the second type may receive the first message indicating the first set of SSBs.

At 310, the UE 115-c may receive a second message based on the UE 115-c being the second type of UE 115. For example, the UE 115-c may receive the second message indicating information associated with one or more random access occasions of the first subset of random access occasions that are unused by the first type of UE 115.

For example, the second message may indicate a second subset of random access occasions. The first subset of random access occasions may include the one or more random access occasions, and the second subset of random access occasions may exclude the one or more random access occasions.

In some examples, the first message may indicate a first set of SSBs associated with the first subset of random access occasions, and the second message may indicate a second set of SSBs associated with a second subset of random access occasions. The first set of SSBs may be indicated as SSBs available for transmission, and the second set of SSBs may be indicated as transmitted SSBs. Random access occasions that correspond to SSBs that are indicated as transmitted but not actually transmitted may not be used by the first type of UE 115. The UE 115-c may identify the one or more random access occasions based on the SSBs that are indicated as transmitted but are not actually transmitted by the network entity 105-b. In some examples, the first message may indicate a bitmap having a first length to indicate the first set of SSBs. The second message may indicate a bitmap having a second length to indicate the second set of SSBs. The bitmap having the second length may have finer granularity, such that the network entity 105-b can indicate that one or more SSBs previously indicated as available are not actually transmitted. In some cases, the second length may be larger than the first length. For example, the first length may be eight bits, and the second length may be sixteen bits.

In some examples, the network entity 105-b may explicitly indicate additional random access occasions or random access channel resources to the UE 115-c. For example, the second message may indicate the one or more random access occasions that are unused by the first type of UE 115, a set of SSBs corresponding to the one or more random access occasions that are unused by the first type of UE 115, or both. In some examples, the second message may indicate the one or more random access occasions that are unused by the first type of UE 115 and one or more additional random access occasions that are excluded from the set of random access occasions. For example, the second message may indicate additional random access occasions that are not configured for the first type of UE 115.

In some examples, the UE 115-c may revalidate one or more random access occasions. For example, the UE 115-c may identify a subset of random access occasions that are invalidated for UEs 115 of the first type of UE 115. A random access occasion may be invalidated based on being within a threshold quantity of symbols after a downlink symbol or an SSB. The second message may indicate an updated TDD pattern or other information which the UE 115-c may use to revalidate the one or more random access occasions. For example, the network entity 105-b may indicate that a downlink symbol period is not used for any downlink signaling, and the UE 115-c may revalidate one or more random access occasions within the threshold quantity of symbol periods after the downlink symbol period.

In some examples, the UE 115-c may receive an SSB from the network entity 105-b at 315. The UE 115-c may receive the SSB based on the second message. For example, the UE 115-c may receive an actually transmitted SSB based on the indication of which SSBs are actually transmitted by the network entity 105-b. The UE 115-c may map the SSB to a random access occasion from the one or more random access occasions that are unused by the first type of UE 115 based on the first message. For example, the UE 115-c may identify one or more random access occasions that correspond to a non-transmitted SSB, and the UE 115-c may map the received SSB to the one or more random access occasions corresponding to the non-transmitted SSB.

At 320, the UE 115-c may transmit a random access preamble. For example, the UE 115-c may transmit the random access preamble using the random access occasion from the one or more random access occasions that are unused by the first type of UE 115.

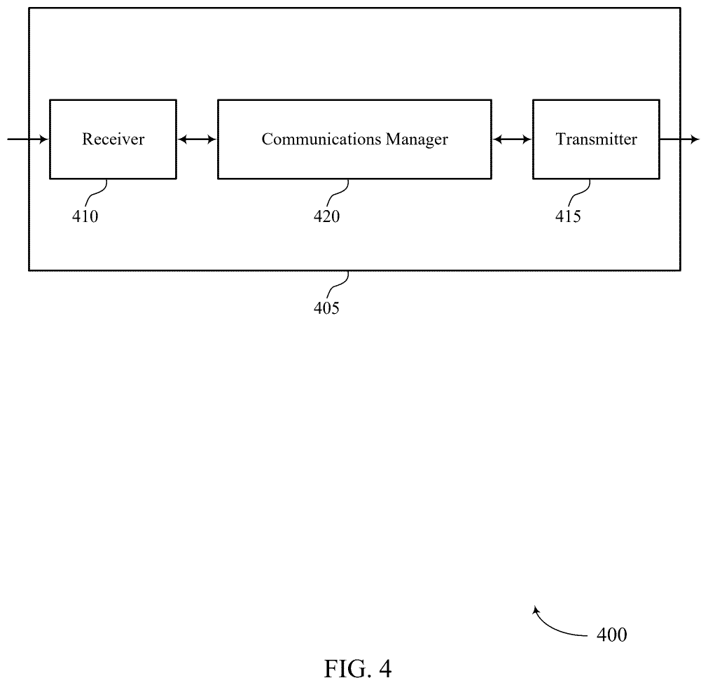

FIG. 4 shows a block diagram 400 of a device 405 that supports random access channel adaptation for random access occasions in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to random access channel adaptation for random access occasions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to random access channel adaptation for random access occasions). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of random access channel adaptation for random access occasions as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving a first message indicating a first subset of random access occasions of a set of random access occasions, the first subset of random access occasions associated with use by a first type of UE for transmission of random access messages. The communications manager 420 is capable of, configured to, or operable to support a means for receiving, based on the UE being a second type of UE, a second message indicating information associated with one or more random access occasions of the first subset of random access occasions that are unused by the first type of UE. The communications manager 420 is capable of, configured to, or operable to support a means for transmitting a random access preamble using a random access occasion from the one or more random access occasions that are unused by the first type of UE.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for more efficient utilization of communication resources.

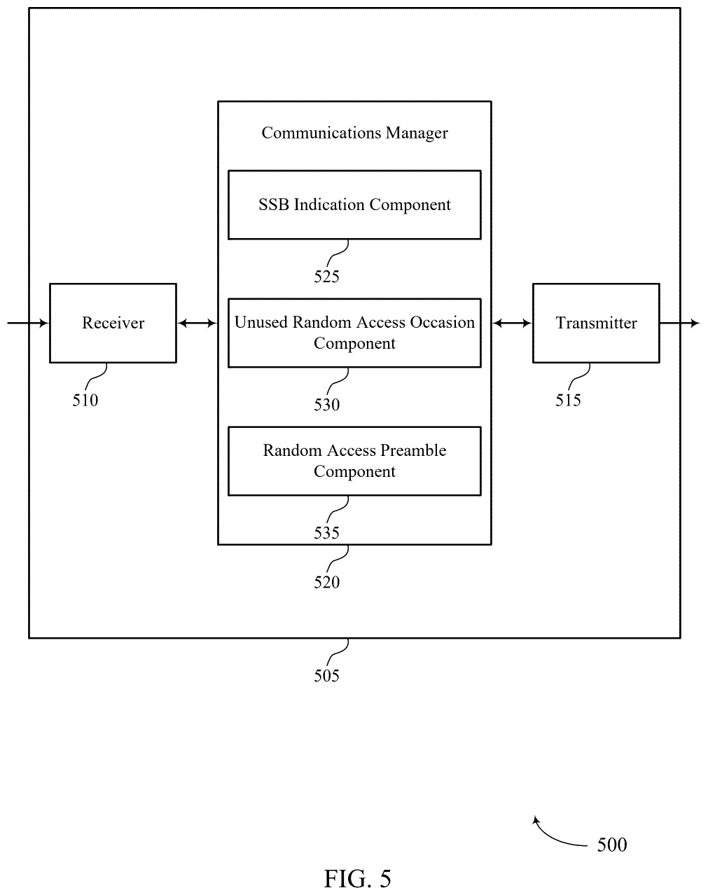

FIG. 5 shows a block diagram 500 of a device 505 that supports random access channel adaptation for random access occasions in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to random access channel adaptation for random access occasions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to random access channel adaptation for random access occasions). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of random access channel adaptation for random access occasions as described herein. For example, the communications manager 520 may include an SSB indication component 525, an unused random access occasion component 530, a random access preamble component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The SSB indication component 525 is capable of, configured to, or operable to support a means for receiving a first message indicating a first subset of random access occasions of a set of random access occasions, the first subset of random access occasions associated with use by a first type of UE for transmission of random access messages. The unused random access occasion component 530 is capable of, configured to, or operable to support a means for receiving, based on the UE being a second type of UE, a second message indicating information associated with one or more random access occasions of the first subset of random access occasions that are unused by the first type of UE. The random access preamble component 535 is capable of, configured to, or operable to support a means for transmitting a random access preamble using a random access occasion from the one or more random access occasions that are unused by the first type of UE.

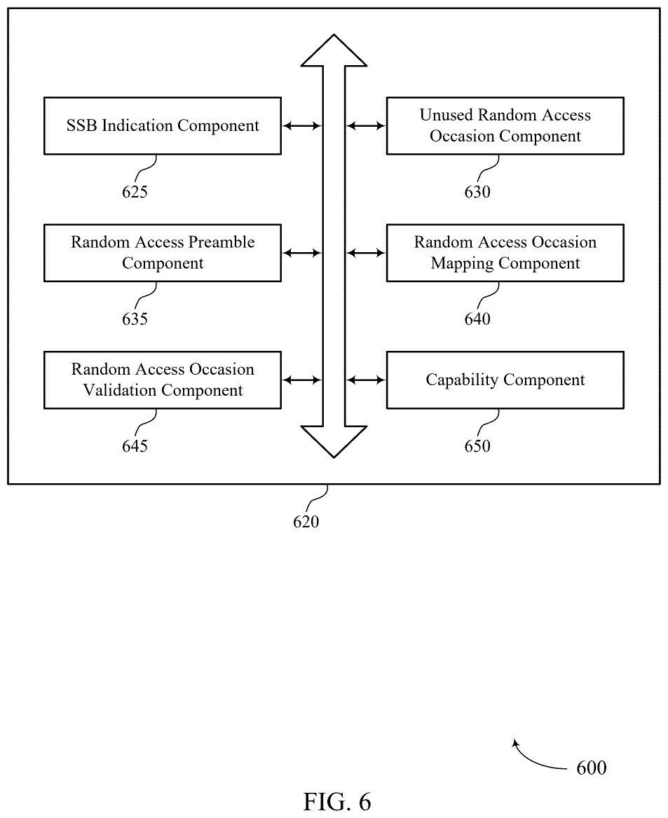

FIG. 6 shows a block diagram 600 of a communications manager 620 that supports random access channel adaptation for random access occasions in accordance with one or more aspects of the present disclosure. The communications manager 620 may be an example of aspects of a communications manager 420, a communications manager 520, or both, as described herein. The communications manager 620, or various components thereof, may be an example of means for performing various aspects of random access channel adaptation for random access occasions as described herein. For example, the communications manager 620 may include an SSB indication component 625, an unused random access occasion component 630, a random access preamble component 635, a random access occasion mapping component 640, a random access occasion validation component 645, a capability component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The SSB indication component 625 is capable of, configured to, or operable to support a means for receiving a first message indicating a first subset of random access occasions of a set of random access occasions, the first subset of random access occasions associated with use by a first type of UE for transmission of random access messages. The unused random access occasion component 630 is capable of, configured to, or operable to support a means for receiving, based on the UE being a second type of UE, a second message indicating information associated with one or more random access occasions of the first subset of random access occasions that are unused by the first type of UE. The random access preamble component 635 is capable of, configured to, or operable to support a means for transmitting a random access preamble using a random access occasion from the one or more random access occasions that are unused by the first type of UE.

In some examples, to support receiving the second message, the unused random access occasion component 630 is capable of, configured to, or operable to support a means for receiving, based on the UE being the second type of UE, an indication of a second subset of random access occasions, where the first subset of random access occasions includes the one or more random access occasions, and the second subset of random access occasions excludes the one or more random access occasions.

In some examples, the second subset of random access occasions corresponds to a set of synchronization signal blocks that are transmitted by a network entity.

In some examples, the first message indicates a first set of synchronization signal blocks associated with the first subset of random access occasions, and the second message indicates a second set of synchronization signal blocks associated with a second subset of random access occasions. In some examples, the first set of synchronization signal blocks are indicated as synchronization signal blocks available for transmission, and the second set of synchronization signal blocks are indicated as transmitted synchronization signal blocks.

In some examples, the first message indicates a bitmap having a first length to indicate the first set of synchronization signal blocks, and the second message indicates a bitmap having a second length to indicate the second set of synchronization signal blocks, the second length being larger than the first length.

In some examples, the one or more random access occasions are included in the first subset of random access occasions and excluded by the second subset of random access occasions.

In some examples, the second message indicates the one or more random access occasions that are unused by the first type of UE, a set of synchronization signal blocks corresponding to the one or more random access occasions that are unused by the first type of UE, or both.

In some examples, the random access occasion mapping component 640 is capable of, configured to, or operable to support a means for receiving a synchronization signal block based on the second message. In some examples, the random access occasion mapping component 640 is capable of, configured to, or operable to support a means for mapping the synchronization signal block to the random access occasion from the one or more random access occasions that are unused by the first type of UE based on the first message.

In some examples, the second message indicates the one or more random access occasions that are unused by the first type of UE and one or more additional random access occasions that are excluded from the set of random access occasions.

In some examples, the second message is received via system information, dedicated radio resource control signaling, downlink control information, a MAC CE, or any combination thereof.

In some examples, the random access occasion validation component 645 is capable of, configured to, or operable to support a means for validating the one or more random access occasions based on the second message and the one or more random access occasions being invalidated for the first type of UE.

In some examples, the second message indicates random access occasion resources for the one or more random access occasions including a slot index, random access occasion index, frame index, or any combination thereof, corresponding to random access occasions that are invalidated for the first type of UE and revalidated for the second type of UE.

In some examples, the random access preamble component 635 is capable of, configured to, or operable to support a means for measuring a reference signal to obtain a reference signal received power measurement or a path loss measurement, or both, where transmitting the random access preamble using the random access occasion is based on the reference signal received power measurement or the path loss measurement, or both, satisfying a threshold.

In some examples, the random access occasion validation component 645 is capable of, configured to, or operable to support a means for identifying the one or more random access occasions that are unused by the first type of UE based on a first time division duplex pattern indicated for the first type of UE and a second time division duplex pattern indicated by the second message, where the one or more random access occasions are unused by the first type of UE based on one or more symbols of the second time division duplex pattern not being used for downlink.

In some examples, the capability component 650 is capable of, configured to, or operable to support a means for transmitting a capability message indicating a capability of the UE to use random access occasions that are unused by the first type of UE.

In some examples, the random access preamble is transmitted using the random access occasion from the one or more random access occasions based on the UE operating in a connected state.

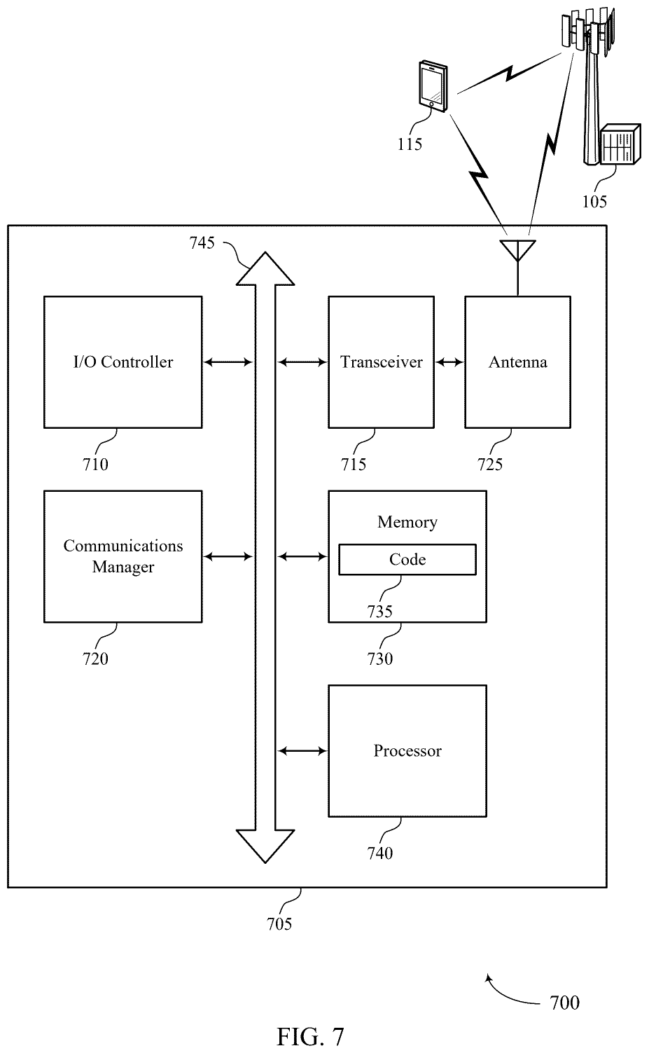

FIG. 7 shows a diagram of a system 700 including a device 705 that supports random access channel adaptation for random access occasions in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting random access channel adaptation for random access occasions). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving a first message indicating a first subset of random access occasions of a set of random access occasions, the first subset of random access occasions associated with use by a first type of UE for transmission of random access messages. The communications manager 720 is capable of, configured to, or operable to support a means for receiving, based on the UE being a second type of UE, a second message indicating information associated with one or more random access occasions of the first subset of random access occasions that are unused by the first type of UE. The communications manager 720 is capable of, configured to, or operable to support a means for transmitting a random access preamble using a random access occasion from the one or more random access occasions that are unused by the first type of UE.

By including or configuring the communications manager 720 in accordance with examples as described herein, the device 705 may support techniques for reduced latency, reduced power consumption, and more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of random access channel adaptation for random access occasions as described herein, or the at least one processor 740 and the at least one memory 730 may be otherwise configured to, individually or collectively, perform or support such operations.

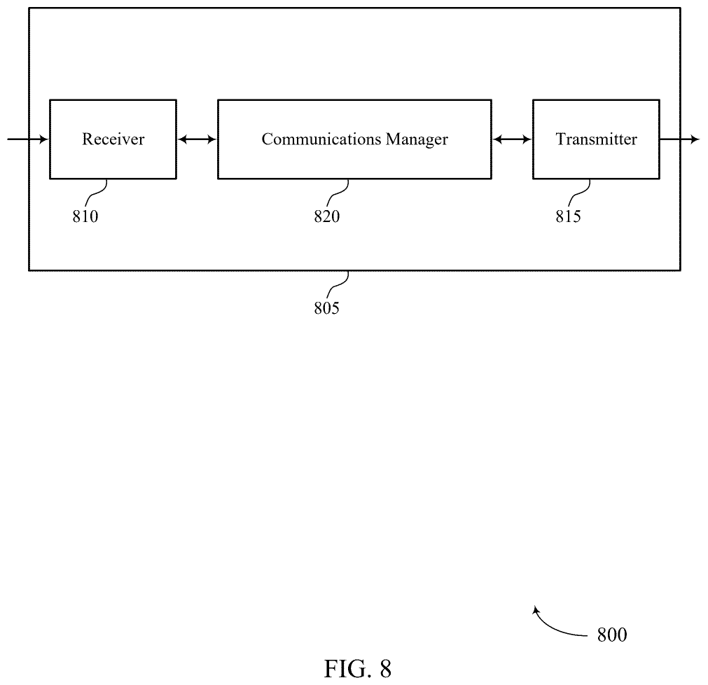

FIG. 8 shows a block diagram 800 of a device 805 that supports random access channel adaptation for random access occasions in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of random access channel adaptation for random access occasions as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting a first message indicating a first subset of random access occasions of a set of random access occasions, the first subset of random access occasions associated with use by a first type of UE for transmission of random access messages. The communications manager 820 is capable of, configured to, or operable to support a means for transmitting a second message associated with a second type of UE, the second message indicating information associated with one or more random access occasions of the first subset of random access occasions that are unused by the first type of UE. The communications manager 820 is capable of, configured to, or operable to support a means for receiving a random access preamble via a random access occasion from the one or more random access occasions that are unused by the first type of UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

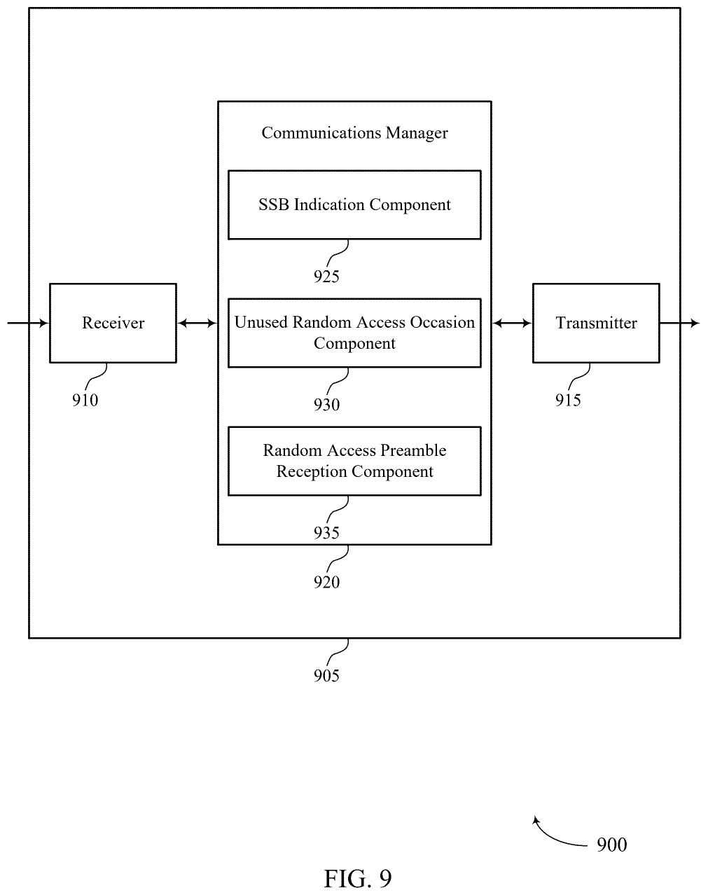

FIG. 9 shows a block diagram 900 of a device 905 that supports random access channel adaptation for random access occasions in accordance with one or more aspects of the present disclosure. The device 905 may be an example of aspects of a device 805 or a network entity 105 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of random access channel adaptation for random access occasions as described herein. For example, the communications manager 920 may include an SSB indication component 925, an unused random access occasion component 930, a random access preamble reception component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SSB indication component 925 is capable of, configured to, or operable to support a means for transmitting a first message indicating a first subset of random access occasions of a set of random access occasions, the first subset of random access occasions associated with use by a first type of UE for transmission of random access messages. The unused random access occasion component 930 is capable of, configured to, or operable to support a means for transmitting a second message associated with a second type of UE, the second message indicating information associated with one or more random access occasions of the first subset of random access occasions that are unused by the first type of UE. The random access preamble reception component 935 is capable of, configured to, or operable to support a means for receiving a random access preamble via a random access occasion from the one or more random access occasions that are unused by the first type of UE.

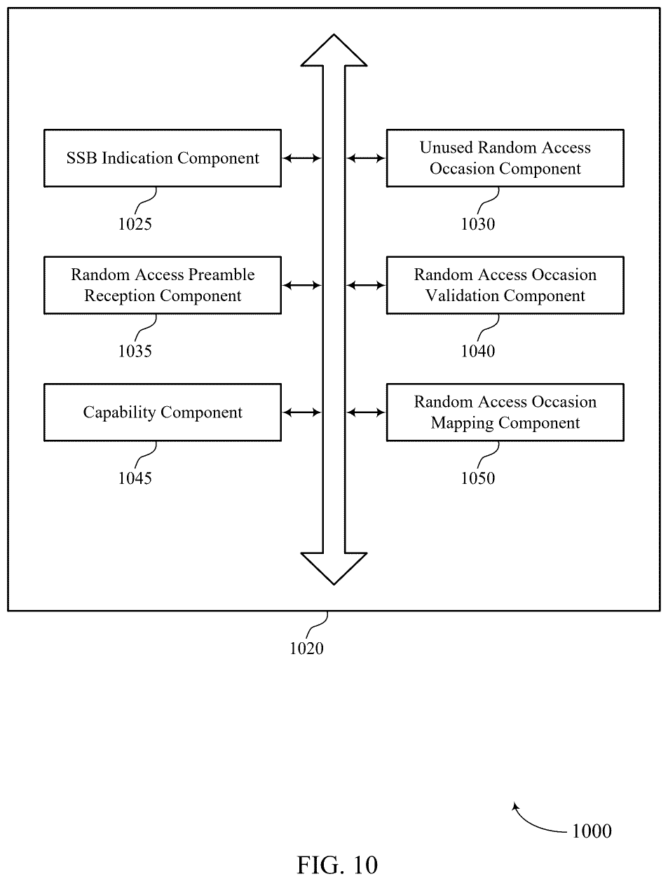

FIG. 10 shows a block diagram 1000 of a communications manager 1020 that supports random access channel adaptation for random access occasions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of random access channel adaptation for random access occasions as described herein. For example, the communications manager 1020 may include an SSB indication component 1025, an unused random access occasion component 1030, a random access preamble reception component 1035, a random access occasion validation component 1040, a capability component 1045, a random access occasion mapping component 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The SSB indication component 1025 is capable of, configured to, or operable to support a means for transmitting a first message indicating a first subset of random access occasions of a set of random access occasions, the first subset of random access occasions associated with use by a first type of UE for transmission of random access messages. The unused random access occasion component 1030 is capable of, configured to, or operable to support a means for transmitting a second message associated with a second type of UE, the second message indicating information associated with one or more random access occasions of the first subset of random access occasions that are unused by the first type of UE. The random access preamble reception component 1035 is capable of, configured to, or operable to support a means for receiving a random access preamble via a random access occasion from the one or more random access occasions that are unused by the first type of UE.

In some examples, to support transmitting the second message, the unused random access occasion component 1030 is capable of, configured to, or operable to support a means for transmitting an indication of a second subset of random access occasions, where the first subset of random access occasions includes the one or more random access occasions, and the second subset of random access occasions excludes the one or more random access occasions.

In some examples, the second subset of random access occasions corresponds to a set of synchronization signal blocks that are transmitted by the network entity.

In some examples, the first message indicates a first set of synchronization signal blocks associated with the first subset of random access occasions, and the second message indicates a second set of synchronization signal blocks associated with a second subset of random access occasions. In some examples, the first set of synchronization signal blocks are indicated as synchronization signal blocks available for transmission, and the second set of synchronization signal blocks are indicated as transmitted synchronization signal blocks.

In some examples, the first message indicates a bitmap having a first length to indicate the first set of synchronization signal blocks, and the second message indicates a bitmap having a second length to indicate the second set of synchronization signal blocks, the second length being larger than the first length.

In some examples, the one or more random access occasions are included in the first subset of random access occasions and excluded by the second subset of random access occasions.

In some examples, the random access occasion mapping component 1050 is capable of, configured to, or operable to support a means for transmitting a synchronization signal block from the second set of synchronization signal blocks. In some examples, the random access occasion mapping component 1050 is capable of, configured to, or operable to support a means for receiving, based on the synchronization signal block, the random access preamble via the random access occasion that is associated with the first set of synchronization signal blocks and not the second set of synchronization signal blocks based on the second message.

In some examples, the second message indicates the one or more random access occasions that are unused by the first type of UE, a set of synchronization signal blocks corresponding to the one or more random access occasions that are unused by the first type of UE, or both.

In some examples, the unused random access occasion component 1030 is capable of, configured to, or operable to support a means for transmitting a first synchronization signal block based on the second message, where the random access preamble is received via the random access occasion associated with a second synchronization signal block that is indicated by the first message and excluded from the second message.

In some examples, the second message indicates the one or more random access occasions that are unused by the first type of UE and one or more additional random access occasions that are excluded from the set of random access occasions.

In some examples, the second message is transmitted via system information, dedicated radio resource control signaling, downlink control information, a MAC CE, or any combination thereof.

In some examples, the second message indicates random access occasion resources for the one or more random access occasions including a slot index, random access occasion index, frame index, or any combination thereof, corresponding to random access occasions that are invalidated for the first type of UE and revalidated for the second type of UE.

In some examples, the random access preamble reception component 1035 is capable of, configured to, or operable to support a means for transmitting a reference signal, where the random access preamble is received via the random access occasion based on a reference signal received power measurement of the reference signal or a path loss measurement of the reference signal, or both, satisfying a threshold.

In some examples, the random access occasion validation component 1040 is capable of, configured to, or operable to support a means for transmitting an indication of a first time division duplex pattern that invalidates the one or more random access occasions, where the second message includes a second time division duplex pattern that validates the one or more random access occasions for the second type of UE.

In some examples, the one or more random access occasions are unused by the first type of UE based on one or more symbols of the second time division duplex pattern not being used for downlink.

In some examples, the capability component 1045 is capable of, configured to, or operable to support a means for receiving a capability message indicating a capability of a UE to use random access occasions that are unused by the first type of UE, where transmitting the second message is based on the capability of the UE.

In some examples, the random access preamble is transmitted using the random access occasion from the one or more random access occasions based on one or more UEs operating in a connected state.

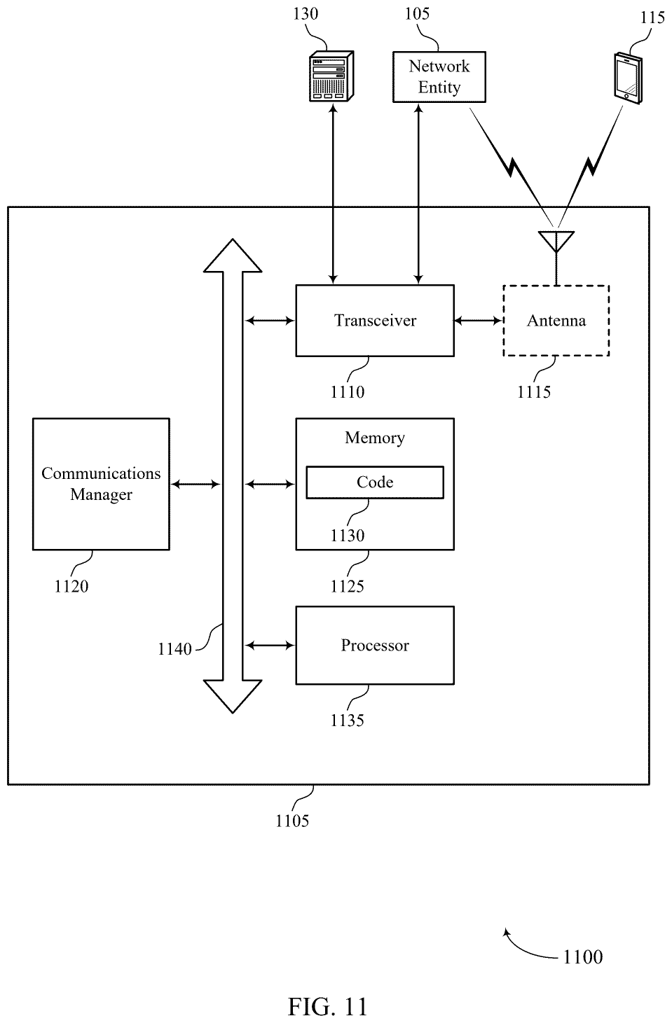

FIG. 11 shows a diagram of a system 1100 including a device 1105 that supports random access channel adaptation for random access occasions in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting random access channel adaptation for random access occasions). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting a first message indicating a first subset of random access occasions of a set of random access occasions, the first subset of random access occasions associated with use by a first type of UE for transmission of random access messages. The communications manager 1120 is capable of, configured to, or operable to support a means for transmitting a second message associated with a second type of UE, the second message indicating information associated with one or more random access occasions of the first subset of random access occasions that are unused by the first type of UE. The communications manager 1120 is capable of, configured to, or operable to support a means for receiving a random access preamble via a random access occasion from the one or more random access occasions that are unused by the first type of UE.

By including or configuring the communications manager 1120 in accordance with examples as described herein, the device 1105 may support techniques for reduced latency, reduced power consumption, and more efficient utilization of communication resources.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of random access channel adaptation for random access occasions as described herein, or the at least one processor 1135 and the at least one memory 1125 may be otherwise configured to, individually or collectively, perform or support such operations.

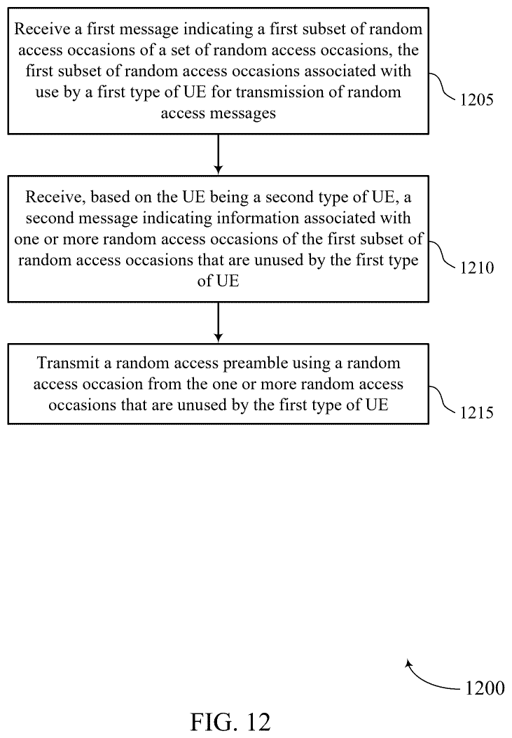

FIG. 12 shows a flowchart illustrating a method 1200 that supports random access channel adaptation for random access occasions in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first message indicating a first subset of random access occasions of a set of random access occasions, the first subset of random access occasions associated with use by a first type of UE for transmission of random access messages. The operations of 1205 may be performed in accordance with examples as disclosed herein. In some examples, aspects of the operations of 1205 may be performed by an SSB indication component 625 as described herein with reference to FIG. 6.

At 1210, the method may include receiving, based at least in part on the UE being a second type of UE, a second message indicating information associated with one or more random access occasions of the first subset of random access occasions that are unused by the first type of UE. The operations of 1210 may be performed in accordance with examples as disclosed herein. In some examples, aspects of the operations of 1210 may be performed by an unused random access occasion component 630 as described herein with reference to FIG. 6.

At 1215, the method may include transmitting a random access preamble using a random access occasion from the one or more random access occasions that are unused by the first type of UE. The operations of 1215 may be performed in accordance with examples as disclosed herein. In some examples, aspects of the operations of 1215 may be performed by a random access preamble component 635 as described herein with reference to FIG. 6.

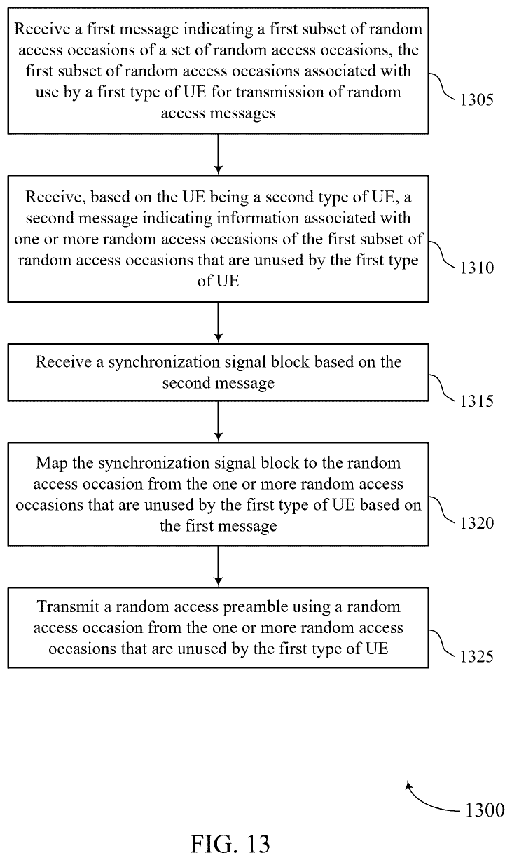

FIG. 13 shows a flowchart illustrating a method 1300 that supports random access channel adaptation for random access occasions in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving a first message indicating a first subset of random access occasions of a set of random access occasions, the first subset of random access occasions associated with use by a first type of UE for transmission of random access messages. The operations of 1305 may be performed in accordance with examples as disclosed herein. In some examples, aspects of the operations of 1305 may be performed by an SSB indication component 625 as described herein with reference to FIG. 6.

At 1310, the method may include receiving, based at least in part on the UE being a second type of UE, a second message indicating information associated with one or more random access occasions of the first subset of random access occasions that are unused by the first type of UE. The operations of 1310 may be performed in accordance with examples as disclosed herein. In some examples, aspects of the operations of 1310 may be performed by an unused random access occasion component 630 as described herein with reference to FIG. 6.

At 1315, the method may include receiving a synchronization signal block based at least in part on the second message. The operations of 1315 may be performed in accordance with examples as disclosed herein. In some examples, aspects of the operations of 1315 may be performed by a random access occasion mapping component 640 as described herein with reference to FIG. 6.

At 1320, the method may include mapping the synchronization signal block to the random access occasion from the one or more random access occasions that are unused by the first type of UE based at least in part on the first message. The operations of 1320 may be performed in accordance with examples as disclosed herein. In some examples, aspects of the operations of 1320 may be performed by a random access occasion mapping component 640 as described herein with reference to FIG. 6.

At 1325, the method may include transmitting a random access preamble using a random access occasion from the one or more random access occasions that are unused by the first type of UE. The operations of 1325 may be performed in accordance with examples as disclosed herein. In some examples, aspects of the operations of 1325 may be performed by a random access preamble component 635 as described herein with reference to FIG. 6.

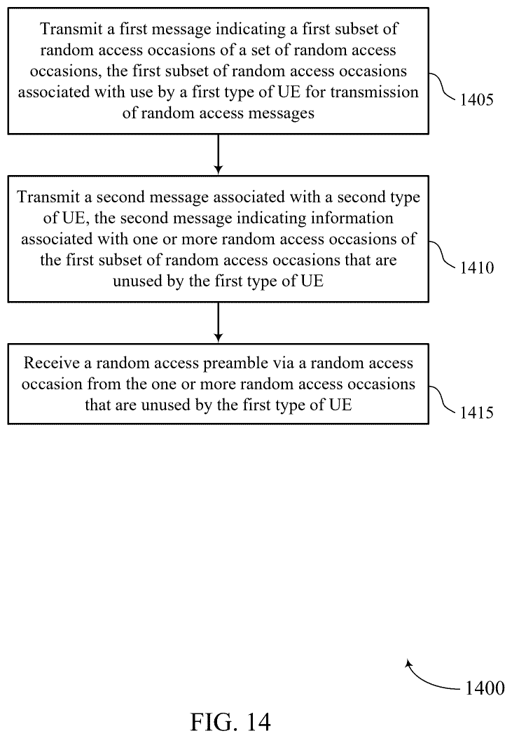

FIG. 14 shows a flowchart illustrating a method 1400 that supports random access channel adaptation for random access occasions in accordance with one or more aspects of the present disclosure. The operations of the method 1400 may be implemented by a network entity or its components as described herein. For example, the operations of the method 1400 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1405, the method may include transmitting a first message indicating a first subset of random access occasions of a set of random access occasions, the first subset of random access occasions associated with use by a first type of UE for transmission of random access messages. The operations of 1405 may be performed in accordance with examples as disclosed herein. In some examples, aspects of the operations of 1405 may be performed by an SSB indication component 1025 as described herein with reference to FIG. 10.

At 1410, the method may include transmitting a second message associated with a second type of UE, the second message indicating information associated with one or more random access occasions of the first subset of random access occasions that are unused by the first type of UE. The operations of 1410 may be performed in accordance with examples as disclosed herein. In some examples, aspects of the operations of 1410 may be performed by an unused random access occasion component 1030 as described herein with reference to FIG. 10.

At 1415, the method may include receiving a random access preamble via a random access occasion from the one or more random access occasions that are unused by the first type of UE. The operations of 1415 may be performed in accordance with examples as disclosed herein. In some examples, aspects of the operations of 1415 may be performed by a random access preamble reception component 1035 as described herein with reference to FIG. 10.

The following provides an overview of aspects of the present disclosure:

Aspect 1: A method for wireless communications at a UE, comprising: receiving a first message indicating a first subset of random access occasions of a set of random access occasions, the first subset of random access occasions associated with use by a first type of UE for transmission of random access messages; receiving, based at least in part on the UE being a second type of UE, a second message indicating information associated with one or more random access occasions of the first subset of random access occasions that are unused by the first type of UE; and transmitting a random access preamble using a random access occasion from the one or more random access occasions that are unused by the first type of UE.

Aspect 2: The method of aspect 1, wherein receiving the second message comprises: receiving, based at least in part on the UE being the second type of UE, an indication of a second subset of random access occasions, wherein the first subset of random access occasions includes the one or more random access occasions, and the second subset of random access occasions excludes the one or more random access occasions.

Aspect 3: The method of aspect 2, wherein the second subset of random access occasions corresponds to a set of synchronization signal blocks that are transmitted by a network entity.

Aspect 4: The method of any of aspects 2 through 3, wherein the first message indicates a first set of synchronization signal blocks associated with the first subset of random access occasions, and the second message indicates a second set of synchronization signal blocks associated with a second subset of random access occasions, the first set of synchronization signal blocks are indicated as synchronization signal blocks available for transmission, and the second set of synchronization signal blocks are indicated as transmitted synchronization signal blocks.

Aspect 5: The method of aspect 4, wherein the first message indicates a bitmap having a first length to indicate the first set of synchronization signal blocks, and the second message indicates a bitmap having a second length to indicate the second set of synchronization signal blocks, the second length being larger than the first length.

Aspect 6: The method of any of aspects 4 through 5, wherein the one or more random access occasions are included in the first subset of random access occasions and excluded by the second subset of random access occasions.

Aspect 7: The method of any of aspects 2 through 6, wherein the second message indicates the one or more random access occasions that are unused by the first type of UE, a set of synchronization signal blocks corresponding to the one or more random access occasions that are unused by the first type of UE, or both.

Aspect 8: The method of any of aspects 2 through 7, further comprising: receiving a synchronization signal block based at least in part on the second message; and mapping the synchronization signal block to the random access occasion from the one or more random access occasions that are unused by the first type of UE based at least in part on the first message.

Aspect 9: The method of any of aspects 2 through 8, wherein the second message indicates the one or more random access occasions that are unused by the first type of UE and one or more additional random access occasions that are excluded from the set of random access occasions.

Aspect 10: The method of any of aspects 2 through 9, wherein the second message is received via system information, dedicated radio resource control signaling, downlink control information, a medium access control (MAC) control element (CE), or any combination thereof.

Aspect 11: The method of any of aspects 2 through 10, further comprising: validating the one or more random access occasions based at least in part on the second message and the one or more random access occasions being invalidated for the first type of UE.

Aspect 12: The method of any of aspects 2 through 11, wherein the second message indicates random access occasion resources for the one or more random access occasions comprising a slot index, random access occasion index, frame index, or any combination thereof, corresponding to random access occasions that are invalidated for the first type of UE and revalidated for the second type of UE.

Aspect 13: The method of any of aspects 1 through 12, further comprising: measuring a reference signal to obtain a reference signal received power measurement or a path loss measurement, or both, wherein transmitting the random access preamble using the random access occasion is based at least in part on the reference signal received power measurement or the path loss measurement, or both, satisfying a threshold.

Aspect 14: The method of any of aspects 1 through 13, further comprising: identifying the one or more random access occasions that are unused by the first type of UE based at least in part on a first time division duplex pattern indicated for the first type of UE and a second time division duplex pattern indicated by the second message, wherein the one or more random access occasions correspond to one or more symbols of the second time division duplex pattern that are not configured for downlink.

Aspect 15: The method of any of aspects 1 through 14, further comprising: transmitting a capability message indicating a capability of the UE to use random access occasions that are unused by the first type of UE.

Aspect 16: The method of any of aspects 1 through 15, wherein the random access preamble is transmitted using the random access occasion from the one or more random access occasions based at least in part on the UE operating in a connected state.

Aspect 17: A method for wireless communications at a network entity, comprising: transmitting a first message indicating a first subset of random access occasions of a set of random access occasions, the first subset of random access occasions associated with use by a first type of UE for transmission of random access messages; transmitting a second message associated with a second type of UE, the second message indicating information associated with one or more random access occasions of the first subset of random access occasions that are unused by the first type of UE; and receiving a random access preamble via a random access occasion from the one or more random access occasions that are unused by the first type of UE.

Aspect 18: The method of aspect 17, wherein transmitting the second message comprises: transmitting an indication of a second subset of random access occasions, wherein the first subset of random access occasions includes the one or more random access occasions, and the second subset of random access occasions excludes the one or more random access occasions.

Aspect 19: The method of aspect 18, wherein the second subset of random access occasions corresponds to a set of synchronization signal blocks that are transmitted by the network entity.

Aspect 20: The method of any of aspects 17 through 19, wherein the first message indicates a first set of synchronization signal blocks associated with the first subset of random access occasions, and the second message indicates a second set of synchronization signal blocks associated with a second subset of random access occasions, the first set of synchronization signal blocks are indicated as synchronization signal blocks available for transmission, and the second set of synchronization signal blocks are indicated as transmitted synchronization signal blocks.

Aspect 21: The method of aspect 20, wherein the first message indicates a bitmap having a first length to indicate the first set of synchronization signal blocks, and the second message indicates a bitmap having a second length to indicate the second set of synchronization signal blocks, the second length being larger than the first length.

Aspect 22: The method of any of aspects 20 through 21, wherein the one or more random access occasions are included in the first subset of random access occasions and excluded by the second subset of random access occasions.

Aspect 23: The method of any of aspects 20 through 22, further comprising: transmitting a synchronization signal block from the second set of synchronization signal blocks; and receiving, based at least in part on the synchronization signal block, the random access preamble via the random access occasion that is associated with the first set of synchronization signal blocks and not the second set of synchronization signal blocks based at least in part on the second message.

Aspect 24: The method of any of aspects 17 through 23, wherein the second message indicates the one or more random access occasions that are unused by the first type of UE, a set of synchronization signal blocks corresponding to the one or more random access occasions that are unused by the first type of UE, or both.

Aspect 25: The method of any of aspects 17 through 24, further comprising: transmitting a first synchronization signal block based at least in part on the second message, wherein the random access preamble is received via the random access occasion associated with a second synchronization signal block that is indicated by the first message and excluded from the second message.

Aspect 26: The method of any of aspects 17 through 25, wherein the second message indicates the one or more random access occasions that are unused by the first type of UE and one or more additional random access occasions that are excluded from the set of random access occasions.

Aspect 27: The method of any of aspects 17 through 26, wherein the second message is transmitted via system information, dedicated radio resource control signaling, downlink control information, a medium access control (MAC) control element (CE), or any combination thereof.

Aspect 28: The method of any of aspects 17 through 27, wherein the second message indicates random access occasion resources for the one or more random access occasions comprising a slot index, random access occasion index, frame index, or any combination thereof, corresponding to random access occasions that are invalidated for the first type of UE and revalidated for the second type of UE.

Aspect 29: The method of any of aspects 17 through 28, further comprising: transmitting a reference signal, wherein the random access preamble is received via the random access occasion based at least in part on a reference signal received power measurement of the reference signal or a path loss measurement of the reference signal, or both, satisfying a threshold.

Aspect 30: The method of any of aspects 17 through 29, further comprising: transmitting an indication of a first time division duplex pattern that invalidates the one or more random access occasions, wherein the second message comprises a second time division duplex pattern that validates the one or more random access occasions for the second type of UE.

Aspect 31: The method of aspect 30, wherein the one or more random access occasions correspond to one or more symbols of the second time division duplex pattern that are not configured for downlink.

Aspect 32: The method of any of aspects 17 through 31, further comprising: receiving a capability message indicating a capability of a UE to use random access occasions that are unused by the first type of UE, wherein transmitting the second message is based at least in part on the capability of the UE.

Aspect 33: The method of any of aspects 17 through 32, wherein the random access preamble is transmitted using the random access occasion from the one or more random access occasions based at least in part on one or more user equipment (UEs) operating in a connected state.

Aspect 34: A UE for wireless communications, comprising one or more memories storing processor-executable code, and one or more processors coupled with the one or more memories and individually or collectively operable to execute the code to cause the UE to perform a method of any of aspects 1 through 16.

Aspect 35: A UE for wireless communications, comprising at least one means for performing a method of any of aspects 1 through 16.

Aspect 36: A non-transitory computer-readable medium storing code for wireless communications, the code comprising instructions executable by one or more processors to perform a method of any of aspects 1 through 16.

Aspect 37: A network entity for wireless communications, comprising one or more memories storing processor-executable code, and one or more processors coupled with the one or more memories and individually or collectively operable to execute the code to cause the network entity to perform a method of any of aspects 17 through 33.

Aspect 38: A network entity for wireless communications, comprising at least one means for performing a method of any of aspects 17 through 33.

Aspect 39: A non-transitory computer-readable medium storing code for wireless communications, the code comprising instructions executable by one or more processors to perform a method of any of aspects 17 through 33.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. A Iso, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message indicating a first subset of random access occasions of a set of random access occasions, the first subset of random access occasions associated with use by a first type of UE for transmission of random access messages;
determine, based at least in part on the UE being a second type of UE, one or more random access occasions of the first subset of random access occasions that are unused by the first type of UE; and
transmit a random access preamble using a random access occasion from the one or more random access occasions that are unused by the first type of UE.

2. The UE of claim 1, wherein the one or more processors are individually or collectively operable to execute the code to cause the UE to:
receive, based at least in part on the UE being the second type of UE, a second message indicating information associated with the one or more random access occasions that are unused by the first type of UE, wherein determining the one or more random access occasions is based at least in part on the second message.

3. The UE of claim 2, wherein, to receive the second message, the one or more processors are individually or collectively operable to execute the code to cause the UE to:
receive, based at least in part on the UE being the second type of UE, an indication of a second subset of random access occasions, wherein the first subset of random access occasions includes the one or more random access occasions, and the second subset of random access occasions excludes the one or more random access occasions.

4. The UE of claim 3, wherein the second subset of random access occasions corresponds to a set of synchronization signal blocks that are transmitted by a network entity.

5. The UE of claim 2, wherein the first message indicates a first set of synchronization signal blocks associated with the first subset of random access occasions, and the second message indicates a second set of synchronization signal blocks associated with a second subset of random access occasions, and wherein the first set of synchronization signal blocks are indicated as synchronization signal blocks available for transmission, and the second set of synchronization signal blocks are indicated as transmitted synchronization signal blocks.

6. The UE of claim 5, wherein the first message indicates a bitmap having a first length to indicate the first set of synchronization signal blocks, and the second message indicates a bitmap having a second length to indicate the second set of synchronization signal blocks, the second length being larger than the first length.

7. The UE of claim 5, wherein the one or more random access occasions are included in the first subset of random access occasions and excluded by the second subset of random access occasions.

8. The UE of claim 2, wherein the second message indicates the one or more random access occasions that are unused by the first type of UE, a set of synchronization signal blocks corresponding to the one or more random access occasions that are unused by the first type of UE, or both.

9. The UE of claim 2, wherein the one or more processors are individually or collectively further operable to execute the code to cause the UE to:
receive a synchronization signal block based at least in part on the second message; and
map the synchronization signal block to the random access occasion from the one or more random access occasions that are unused by the first type of UE based at least in part on the first message.

10. The UE of claim 2, wherein the second message indicates the one or more random access occasions that are unused by the first type of UE and one or more additional random access occasions that are excluded from the set of random access occasions.

11. The UE of claim 2, wherein the second message is received via system information, dedicated radio resource control signaling, downlink control information, a medium access control (MAC) control element (CE), or any combination thereof.

12. The UE of claim 2, wherein the one or more processors are individually or collectively further operable to execute the code to cause the UE to:
validate the one or more random access occasions based at least in part on the second message and the one or more random access occasions being invalidated for the first type of UE.

13. The UE of claim 2, wherein the second message indicates random access occasion resources for the one or more random access occasions comprising a slot index, random access occasion index, frame index, or any combination thereof, corresponding to random access occasions that are invalidated for the first type of UE and revalidated for the second type of UE.

14. The UE of claim 1, wherein the one or more processors are individually or collectively further operable to execute the code to cause the UE to:
measure a reference signal to obtain a reference signal received power measurement or a path loss measurement, or both, wherein transmitting the random access preamble using the random access occasion is based at least in part on the reference signal received power measurement or the path loss measurement, or both, satisfying a threshold.

15. The UE of claim 2, wherein the one or more processors are individually or collectively further operable to execute the code to cause the UE to:
identify the one or more random access occasions that are unused by the first type of UE based at least in part on a first time division duplex pattern indicated for the first type of UE and a second time division duplex pattern indicated by the second message, wherein the one or more random access occasions are unused by the first type of UE based at least in on one or more symbols of the second time division duplex pattern not being used for downlink.

16. The UE of claim 1, wherein the one or more processors are individually or collectively further operable to execute the code to cause the UE to:
transmit a capability message indicating a capability of the UE to use random access occasions that are unused by the first type of UE.

17. The UE of claim 1, wherein the random access preamble is transmitted using the random access occasion from the one or more random access occasions based at least in part on the UE operating in a connected state.

18. A network entity, comprising:
one or more memories storing processor-executable code; and
one or more processors coupled with the one or more memories and individually or collectively operable to execute the code to cause the network entity to:
transmit a first message indicating a first subset of random access occasions of a set of random access occasions, the first subset of random access occasions associated with use by a first type of user equipment (UE) for transmission of random access messages;
transmit a second message associated with a second type of UE, the second message indicating information associated with one or more random access occasions of the first subset of random access occasions that are unused by the first type of UE; and
receive a random access preamble via a random access occasion from the one or more random access occasions that are unused by the first type of UE.

19. The network entity of claim 18, wherein, to transmit the second message, the one or more processors are individually or collectively operable to execute the code to cause the network entity to:
transmit an indication of a second subset of random access occasions, wherein the first subset of random access occasions includes the one or more random access occasions, and the second subset of random access occasions excludes the one or more random access occasions.

20. A method for wireless communications at a user equipment (UE), comprising:
receiving a first message indicating a first subset of random access occasions of a set of random access occasions, the first subset of random access occasions associated with use by a first type of UE for transmission of random access messages;
determining, based at least in part on the UE being a second type of UE, one or more random access occasions of the first subset of random access occasions that are unused by the first type of UE; and
transmitting a random access preamble using a random access occasion from the one or more random access occasions that are unused by the first type of UE.
